(19) United States
(12) Patent Application Publication
(10) Pub. No.: US 2015/0343667 A1
(43) Pub. Date: Dec. 3, 2015

(54) KNIVES COMPRISING COMPOSITE MATERIALS FOR USE WITH PELLETIZING DIES

(71) Applicant: Kennametal Inc., Latrobe, PA (US)

(72) Inventors: J. Denny Robertson, Bella Vista, AR (US); Debangshu Banerjee, Irwin, PA (US); Hugo Serrano, Lowell, AR (US); Yujiao Zou, Fayetteville, AR (US)

(21) Appl. No.: 14/291,578

(22) Filed: May 30, 2014

(51) Int. Cl. B29B 11/02; C22C 29/08; B02C 18/18; C22C 29/06

(52) U.S. Cl. CPC B29B 11/02; C22C 29/06; C22C 29/067; C22C 29/08; B02C 18/18

(57) ABSTRACT

Pelletizing die and knife assemblies that may be used for pelletization of plastic extrudate are disclosed. The knife assemblies may include an extrusion die and a rotary knife hub assembly. The rotary knife hub assembly may comprise a hub having multiple pelletizer cutting knives mounted thereon. Each knife may include a cutting blade insert mounted on a body of the knife. The cutting blade inserts may comprise a composite material having a continuous metal matrix with hard metal carbide particles dispersed therein. The composite material has relatively high hardness and good wear resistance properties, but may have a hardness less than the hardness of the pelletizing die surface in order to reduce wear of the die face.

### FIELD OF THE INVENTION

The present invention relates to pelletizer die and knife assemblies, and more particularly relates to the use of composite materials in the knives of such assemblies.

### BACKGROUND INFORMATION

A conventional underwater pelletizer device for pelletization of a plastic extrudate generally includes an extrusion die comprising a die body having a die plate wear surface and at least one orifice through which a molten plastic is extruded, and a rotary knife hub assembly comprising a hub having a hub body with at least one knife affixed to the hub body, wherein the knife is at least partially in contact with the die plate wear surface of the die body while the hub is rotating, resulting in the knife cutting the plastic extrudate which has been extruded through the orifice to produce plastic pellets which are cooled and hardened by the water.

A disadvantage of this conventional technology is that the cutting edge of the knife may become dull because of the at least partial contact with the die plate wear surface of the die body during rotation of the rotary knife hub assembly, which results in the production of non-uniformly shaped, low quality plastic pellets. Therefore, the manufacturing process must be halted in order to sharpen the dulled knife or replace the dulled knife with a new or refurbished, sharpened knife, which decreases productivity and increases manufacturing costs.

Another disadvantage of this conventional technology is that the die plate wear surface of the die body may be worn away because of the at least partial contact of the knife with the die plate wear surface during rotation of the rotary knife hub assembly, which results in the production of non-uniformly shaped, low quality plastic pellets. Therefore, the manufacturing process must be halted in order to replace the worn extrusion die with a new or refurbished extrusion die, which is typically expensive and laborious, thereby decreasing productivity and dramatically increasing manufacturing costs.

### SUMMARY OF THE INVENTION

The present invention is directed to pelletizing die and knife assemblies that may be used for pelletization of plastic extrudate. The knife assemblies may include an extrusion die and a rotary knife hub assembly. The rotary knife hub assembly may comprise a hub having multiple pelletizer cutting knives mounted thereon. Each knife may include a cutting blade insert mounted on a body of the knife. The cutting blade inserts may comprise a composite material having a continuous metal matrix with hard metal carbide particles dispersed therein. The composite material has relatively high hardness and good wear resistance properties, but may have a hardness less than the hardness of the pelletizing die surface in order to reduce wear of the die face.

An aspect of the present invention is to provide a pelletizer cutting knife comprising: a wear surface; a rake face having a rake angle of less than 90° with respect to the wear surface; and a cutting edge at the intersection of the wear surface and the rake face, wherein at least a portion of the knife comprises a composite material comprising hard metal carbide particles dispersed in a metal binder alloy matrix.

Another aspect of the present invention is to provide a rotary knife hub assembly comprising: a rotatable hub; at least one pelletizer cutting knife mounted on the rotatable hub, wherein the knife comprises: a wear surface; a rake face having a rake angle of less than 90° with respect to the wear surface; and a cutting edge at the intersection of the wear surface and the rake face, wherein at least a portion of the knife comprises a composite material comprising hard metal carbide particles dispersed in a metal binder alloy matrix.

A further aspect of the present invention is to provide a pelletizing die and knife assembly comprising: an extrusion die having a die plate wear surface and at least one extrusion orifice, and at least one pelletizer cutting knife movable in relation to the extrusion die and having a wear surface contacting the die plate wear surface, wherein the wear surface of the knife comprises a composite material having a hardness of at least 65 HRC but less than a hardness of the die plate wear surface.

Another aspect of the present invention is to provide a composite material for use in a pelletizer cutting knife comprising: from 20 to 40 weight percent of a metal binder alloy; and from 60 to 80 weight percent of hard metal carbide particles dispersed in the metal binder alloy, wherein the composite material has a hardness of from 65 to 75 HRC.

These and other aspects of the present invention will be more apparent from the following description.

### BRIEF DESCRIPTION OF THE DRAWINGS

FIG. 1 is a partially schematic side sectional view illustrating a pelletizing die and knife assembly in accordance with an embodiment of the invention.

FIG. 2 is a bottom view of a rotary knife hub assembly in accordance with an embodiment of the present invention.

FIG. 3 is a cross-sectional end view of a pelletizer cutting knife similar to those shown in FIG. 2 comprising a knife body and a composite cutting blade insert in accordance with an embodiment of the present invention.

FIG. 4 is a bottom isometric view of a pelletizer cutting knife comprising a knife body and a composite cutting blade insert in accordance with another embodiment of the present invention.

FIG. 5 is a top isometric view of the composite cutting blade insert of FIG. 4.

FIG. 6 is a side view of the composite cutting blade insert of FIG. 5.

FIG. 7 is a micrograph of a cutting blade insert composite material in accordance with an embodiment of the present invention.

### DETAILED DESCRIPTION

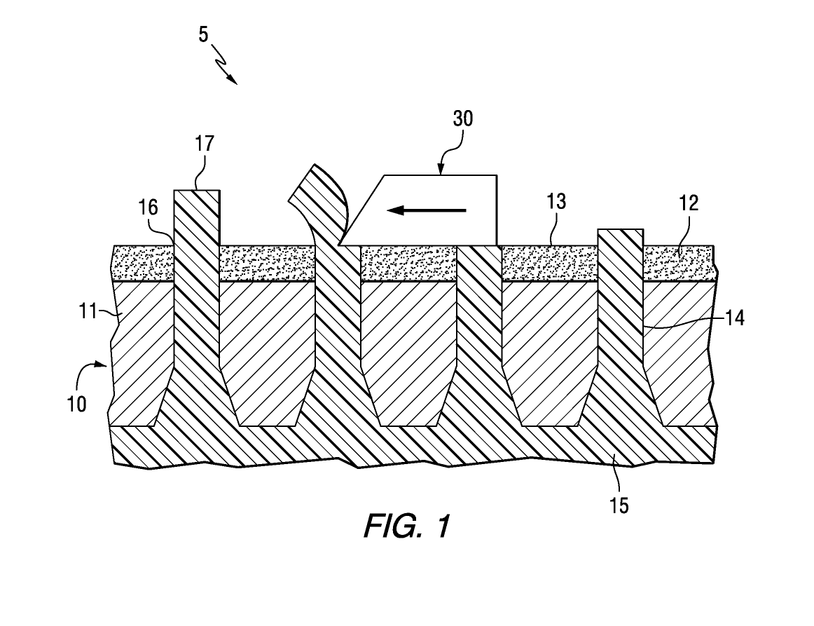

FIG. 1 schematically illustrates a pelletizing die and knife assembly 5 in accordance with an embodiment of the present invention. The assembly 5 includes an extrusion die 10 comprising a die body 11 having a die face plate 12 with a die plate wear surface 13. Multiple extrusion channels 14 and orifices 16 are provided in the die body 11, through which molten plastic 15 is capable of passing and being extruded to produce plastic extrudate 17. As shown in FIG. 1, a pelletizer cutting knife 30 passes in the direction of the arrow over the die plate wear surface 13 of the extrusion die 10, resulting in the knife 30 cutting the plastic extrudate 17 that has been extruded through the orifices 16 to produce plastic pellets 18. In certain embodiments, the pelletizing die and knife assembly 5 is an underwater pelletizer device.

Although not illustrated in FIG. 1, in certain embodiments the die face plate 12, die plate wear surface 13 and/or orifices 16 may be equipped with one or more nibs, wear pads, and combinations thereof conventionally used in pelletizer dies. In certain embodiments, the die body 11 may include one or more heating channels (not shown) which may facilitate maintaining the plastic in a molten state while passing the same through the extrusion channels.

In certain embodiments, the pelletizing die and knife assembly 5 may further comprise conventional adjustment systems (not shown), e.g., a sensor that measures contact pressure between the die plate wear surface 13 and the pelletizer cutting knife 30, a processor for analyzing the signal generated from the pressure sensor, and a control apparatus controlled by the processor for maintaining a desired degree of contact pressure throughout a sacrificial wearing away of the contact surface of the knife 30 during pelletization of the plastic extrudate.

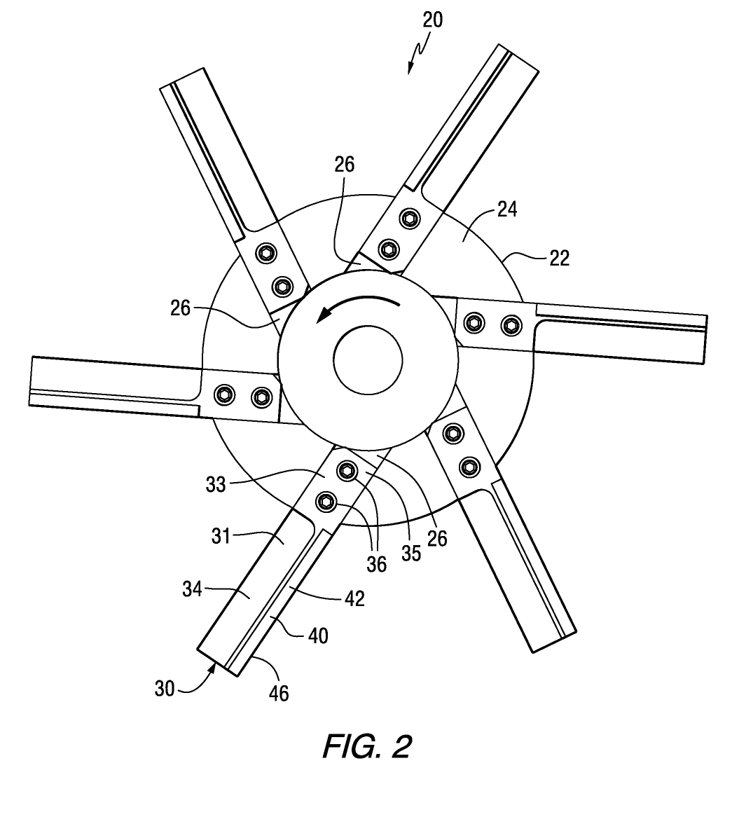

FIG. 2 illustrates a rotary knife hub assembly 20 in accordance with an embodiment of the invention. The rotary knife hub assembly 20 includes a hub 22 having a hub body 24 that is rotatable around an axis as shown by the arrow in FIG. 2. Knife mounting recesses 26 are provided in the bottom surface of the hub body 24. Multiple pelletizer cutting knives 30 are received in the knife mounting recesses 26 of the hub body 24. The knife mounting recesses 26 are oriented such that the knives 30 mounted therein are radially angled in order to facilitate removal of the cut plastic pellets as the hub 22 rotates. Each pelletizer cutting knife 30 comprises a knife body 31 and a composite cutting blade insert 40 affixed to the knife body 31, as more fully described below.

As illustrated in FIG. 2, the pelletizer cutting knife 30 comprises a knife body 31 having a mounting shank 35 with mounting holes 36 configured to affix to the knife mounting recess 26 of the hub body 24 of the rotary knife hub assembly 20. The pelletizer cutting knife 30 may be removably mounted in the knife mounting recess 26 of the hub body 24, e.g., by means of mechanical fasteners such as allen hex bolts or screws. In the embodiment shown in FIG. 2, the mounting shank 35 of each knife 30 is mechanically fastened in a knife mounting recess 26 of the hub body 24 with a plurality of allen hex bolts. However, any other suitable mounting arrangement may be used.

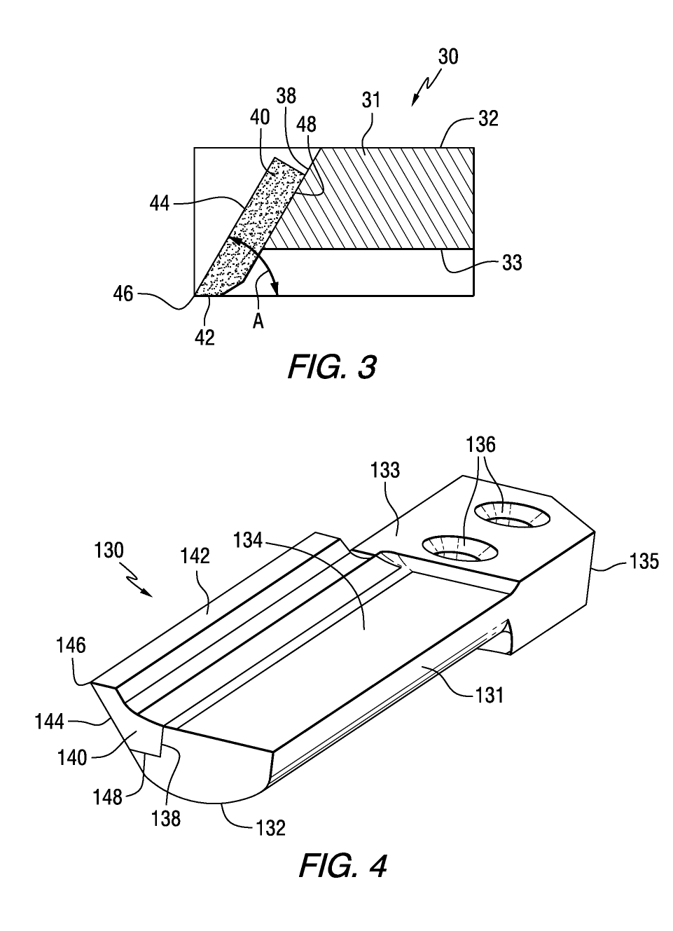

FIG. 3 is a cross-sectional end view of a pelletizer cutting knife 30 similar to those shown in FIG. 2 comprising a knife body 31 and a composite cutting blade insert 40 affixed to a mounting surface 38 of the knife body 31 in accordance with an embodiment of the present invention. Although the pelletizer cutting knife 30 shown in FIG. 3 comprises an insert 40 made of a composite material, it is to be understood that the present invention includes alternative embodiments in which the entire cutting knife may be made of the composite material.

As illustrated in FIGS. 2 and 3, the knife body 31 of the pelletizer cutting knife 30 has a top surface 32 and a bottom surface 33 with a bottom recess 34. The knife body 31 includes a mounting surface 38 for affixing the composite cutting blade insert 40 to the knife body 31. A mounting surface 48 on the composite cutting blade insert 40 contacts the mounting surface 38 of the knife body 31 and may be secured thereto by any suitable means such as brazing, adhesive, or the like. Alternatively, the insert 40 may be removably mounted on the knife body 31 by means of mechanical fasteners, clamps, or the like.

As illustrated in FIG. 3, the composite cutting blade insert 40 of the pelletizer cutting knife 30 comprises a wear surface 42 and a rake face 44 having a rake angle A with respect to the wear surface 42. A cutting edge 46 is formed at the intersection of the wear surface 42 and the rake face 44. In certain embodiments, the rake face 44 of the composite cutting blade insert 40 may have a rake angle A of less than 90° with respect to the wear surface 42, for example, from 10° to 80°, from 20° to 70°, from 30° to 60°, or from 40° to 50°.

In certain embodiments, the wear surface 42 of the composite cutting blade insert 40 is planar and contacts the die plate wear surface 13 of the die face plate 12. In accordance with an aspect of the present invention, the composite cutting blade insert 40 may comprise a composite material that has relatively high hardness and wear resistance properties, but which has a hardness that is less than the hardness of the die face plate 12 in order to reduce wear of the die face plate 12. In certain embodiments, the wear surface 42 of the composite cutting blade insert 40 comprises a sacrificial wear surface that wears away at a faster rate than the die plate wear surface 13 of die face plate 12.

In certain embodiments, the cutting edge 46 of the composite cutting blade insert 40 is self-sharpening. As used herein, the term “self-sharpening” means that the cutting edge is continuously sharpened, and thus does not become overly dull, from contact with the opposing surface of the pelletizer die during operation. In certain embodiments, the provision of a rake angle A of less than 90° and the sacrificial wear of the blade wear surface 42 facilitate the self-sharpening characteristics of the knife 30.

In the embodiment shown in FIG. 3, the rake face 44 and mounting surface 48 lie in planes that are substantially parallel with each other. However, the surface of the insert 40 extending between the mounting surface 48 and the wear surface 42 is tapered or beveled in order to provide a smaller wear surface 42 when the cutting knife 30 is initially installed. Such a relatively small surface area facilitates initial break-in of the cutting knife 30 by reducing the amount of composite material that may be worn away to achieve flush contact with the opposing die plate wear face 13.

FIGS. 4-6 illustrate features of a pelletizer cutting knife 130 in accordance with another embodiment of the present invention. FIG. 4 is a bottom isometric view of the pelletizer cutting knife 130, which comprises a knife body 131 and a composite cutting blade insert 140 affixed to the knife body 131. The knife body 131 has a mounting shank 135 with mounting holes 136 configured for mounting on a hub, such as the hub 22 shown in FIG. 2.

As illustrated in FIG. 4, the knife body 131 of the pelletizer cutting knife 130 has a top surface 132, a bottom surface 133 with a bottom recess 134, and a mounting surface 138 for affixing the composite cutting blade insert 140 to the knife body 131. A mounting surface 148 of the composite cutting blade insert 140 contacts the mounting surface 138 of the knife body 131 and may be secured thereto by brazing or any other suitable means, as described above.

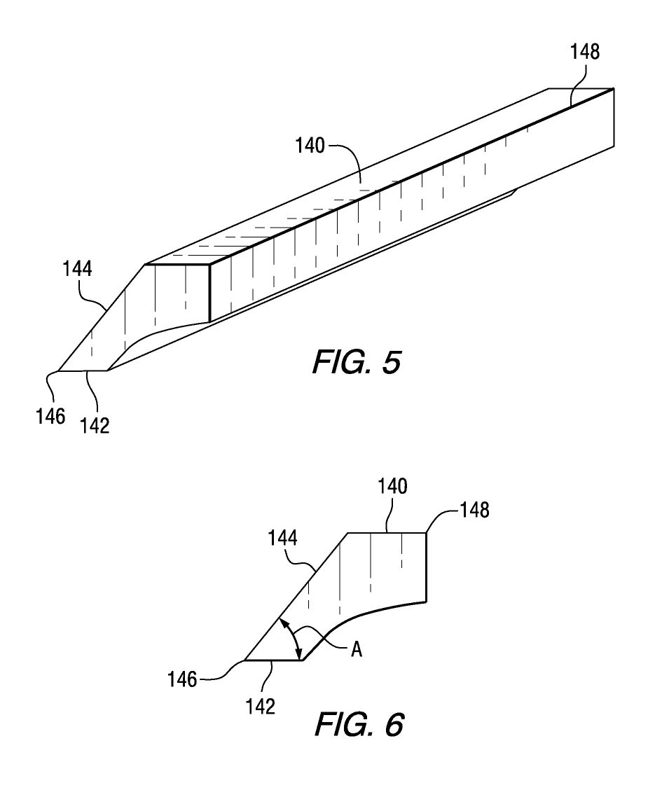

As illustrated in FIGS. 4-6, the composite cutting blade insert 140 of the pelletizer cutting knife 130 comprises a wear surface 142 and a rake face 144 forming a self-sharpening cutting edge 146 at the intersection thereof. As shown in FIG. 6, the rake face 144 is oriented at a rake angle A with respect to the wear surface 142. The rake angle A shown in FIG. 6 may be selected in a similar manner as described in the embodiment shown in FIG. 3.

In accordance with embodiments of the present invention, at least a portion of the pelletizer cutting knives 30 and 130 comprise a composite material. The composite material includes hard metal carbide particles dispersed in a continuous matrix of a metal binder alloy. In certain embodiments, the hard metal carbide particles are present as a discontinuous phase, i.e., the hard metal carbide particles do not form a continuous or connected skeleton of metal carbide material, but rather some or all of the hard metal carbide particles are completely surrounded by the metal binder alloy.

The hard metal carbide particles of the composite material may comprise tungsten carbide (WC), di-tungsten carbide (W₂C), titanium carbide (TiC), tantalum carbide (TaC), chromium carbide (Cr₃C₂) and vanadium carbide (VC). For example, the carbide may comprise WC with up to 10 weight percent W₂C.

In certain embodiments, the hard metal carbide particles may be present in the composite material in an amount of up to 82 or 85 weight percent, based on the total weight of the composite material. For example, the composite material may comprise from 60 to 80 weight percent, or from 65 to 75 weight percent, or from 68 to 72 weight percent of the hard metal carbide particles.

In certain embodiments, the tungsten carbide particles have an average grain size of less than 3 μm, for example, from 0.1 to 2.5 μm, or from 0.5 to 2 μm. While wishing not to be bound by any particular theory, it is believed that tungsten carbide particles having an average grain size of less than 3 μm may impart a superior self-sharpening property to a self-sharpening cutting blade insert comprising a composite material containing such tungsten carbide particles.

In certain embodiments, the hard metal carbide particles may comprise secondary metal carbides such as titanium carbide, tantalum carbide, niobium carbide and the like. The secondary metal carbide may be present in the hard metal carbide particles in an amount of from zero to 20 weight percent or more, based on the total weight of the hard metal carbide particles and secondary metal carbide. In certain embodiments, the secondary metal carbide may comprise from 1 to 15 weight percent, from 6 to 14 weight percent, or from 8 to 12 weight percent. In certain embodiments, the hard metal carbide particles may be substantially free of titanium carbide.

In certain embodiments, the metal binder alloy of the composite material may comprise at least one metal selected from cobalt, nickel, chromium, tungsten, and the like. The metal binder alloy may be present in the composite material in an amount of at least 15 or 18 weight percent, based on the total weight of the composite material. For example, the metal binder alloy may comprise from 20 to 40 weight percent, or from 22 to 35 weight percent, or from 24 to 32 weight percent.

In accordance with certain embodiments, the amount of metal binder alloy present in the composite material is significantly higher than the amount of binder metal conventionally used in cemented carbide materials. While not intending to be bound by any particular theory, the use of a relatively high percentage of binder metal alloy may create spacings between adjacent hard metal carbide particles, thereby reducing contact and sintering between the hard metal carbide particles during production of the composite materials. During production of the composite materials, when starting powders of the hard metal carbide particles and metal binder alloy particles are initially mixed together and formed into a green compact, the volume percentage of the metal binder alloy particles is sufficient to reduce particle-to-particle contact between adjacent hard metal carbide particles. Such physical spacings between the adjacent hard metal carbide particles may prevent most of the hard metal carbide particles from sintering to each other during thermal consolidation of the composite materials. As a result, the hard metal carbide particles may not form a continuous skeleton of sintered metal carbide, but rather remain dispersed as a discontinuous phase in a continuous matrix of the metal binder alloy.

In certain embodiments, the metal binder alloy may comprise cobalt in an amount greater than 50 weight percent, based on the total weight of the metal binder alloy. For example, the cobalt may comprise from 80 to 100 weight percent, from 85 to 99 weight percent, or from 90 to 98 weight percent of the metal binder alloy.

In certain embodiments, a cobalt-based metal binder alloy as described above may also comprise nickel in an amount less than 50 weight percent based on the total weight of the metal binder alloy. For example, the nickel may comprise from zero to 20 weight percent, from 5 to 15 weight percent, or from 8 to 12 weight percent of the metal binder alloy. In certain embodiments, the metal binder alloy may comprise a pre-mixed alloy, such as Co—Cr—Ni—W in the Stellite family.

In certain embodiments, the metal binder alloy may be substantially free of metals such as copper, iron, molybdenum and/or chromium. As used herein, the term “substantially free” means that a particular material is not purposefully added to a composition, and is only present as an impurity or in trace amounts. As used herein, the term “completely free” means that a composition is completely devoid of a particular material.

In certain embodiments, the composite material may further comprise at least one grain growth inhibitor such as chromium carbide, molybdenum carbide, tantalum carbide, niobium carbide, vanadium carbide and the like. For example, the grain growth inhibitor(s) may comprise from 0.01 to 5 weight percent based on the total weight of the composite material, e.g., from 0.1 to 4 weight percent, or from 0.5 to 3 weight percent.

In certain embodiments, the composite material may further comprise a carbon scavenger such as tungsten metal powder, or the like. For example, the tungsten carbon scavenger may comprise from 0.01 to 5 weight percent, based on the total weight of the composite material, e.g., from 0.05 to 3 weight percent, or from 0.2 to 2 weight percent. While not intending to be bound by any particular theory, it is believed that the carbon scavenger may bind to carbon present in the grain growth inhibitor, for example, which may impart a superior corrosion resistance property to a self-sharpening cutting blade insert comprising a composite material containing the carbon scavenger.

In accordance with certain embodiments, the hardness of the composite material is controlled in order to provide extended usage times for the knives during cutting operations while also providing for sacrificial wear of the knives versus the die materials. For example, the composite material may have a hardness that is greater than 65 HRC and less than 75 HRC. For example, the composite material may have a hardness of from 66 to 72 HRC, or from 68 to 70 HRC.

In certain embodiments, the composite material has an abrasion resistance that is greater than 1.8 as measured by the standard ASTM B611 test in which the wear number represents a volume in units of cm³. For example, the ASTM B611 wear number may be from 1.8 to 2.2 or higher, or from 1.85 to 2.0 or 2.1.

The composite materials may be made by a thermal consolidation process. An exemplary process comprises: milling the hard metal carbide particles and the metal binder alloy to obtain a milled powder having a desired grain size; mixing the milled powder with an organic binder to obtain a mixture; pressing the mixture into a green compact having a shape; de-waxing the green compact to remove the organic binder from the green compact to obtain a greenware; and thermally consolidating the greenware to produce the composite material.

Milling the hard metal carbide particles and the metal binder alloy to obtain a milled powder may be carried out using any conventional milling apparatus and/or conventional milling technique or conditions. In certain embodiments, milling includes ball milling the hard metal carbide particles and the metal binder alloy for a period of time sufficient to obtain a milled powder having a desired grain size. A non-limiting example of a desired grain size of the milled powder is less than 3 μm.

In certain embodiments, milling may be carried out in the presence of an organic solvent. If present, the organic solvent may include a volatile organic solvent. Non-limiting examples of organic solvents include, acetone, methanol, ethanol, propanol, pentane, hexane, heptane and the like.

Mixing the milled powder with an organic binder to obtain a mixture may be carried out using any conventional mixing apparatus and/or conventional mixing technique or conditions. The organic binder may be any conventional organic binder, a non-limiting example of which includes a wax, such as a paraffin wax.

Pressing the mixture into a green compact having a desired shape may be carried out using any conventional pressing apparatus and/or conventional pressing technique or conditions. In certain embodiments, pressing includes uniaxial pressing, hot isotactic pressing, cold isotactic pressing, injection molding, extrusion, and combinations thereof. A non-limiting example of a desired shape of the green compact includes a self-sharpening cutting blade insert for a knife, such as a pelletizing knife.

De-waxing the green compact to remove the organic binder from the green compact to obtain a greenware may be carried out using any conventional de-waxing apparatus and/or conventional de-waxing technique or conditions. In certain embodiments, de-waxing includes de-waxing at a temperature of 50-600° C. under a vacuum/H₂ atmosphere. In some embodiments, such a de-waxing step may also serve to remove any organic solvent, if present, from the green compact.

The green compact may then be thermally consolidated by subjecting the material to an elevated temperature sufficient to cause the metal binder alloy particles to sinter together to thereby form a continuous matrix of the metal binder alloy with the hard carbide particles dispersed therein. For example, for a cobalt-based metal binder alloy, a typical consolidation temperature may be in a range of from 1,350 to 1,500° C., for example from 1,380 to 1,480° C., or from 1,430 to 1,450° C. The consolidation temperature may be ramped up at intervals to reach such a peak level, held at the peak level for a suitable amount of time (e.g., 1 to 30 minutes), and then cooled down slowly.

In accordance with certain embodiments, the thermal consolidation temperatures are selected such that the metal binder alloy particles contained in the green compact are sintered together to form a continuous matrix of the metal binder alloy while substantially avoiding sintering of the hard metal carbide particles to each other. As described above, the presence of a relatively large amount of metal binder alloy in the green compact tends to create spacings between the adjacent hard metal carbide particles, i.e., each individual hard metal carbide particle is unlikely to have many contact points with other hard metal carbide particles. Due to such spacings between the hard metal carbide particles, they tend not to sinter to each other but rather remain as discrete particles during the thermal consolidation process, which results in the formation of a discontinuous hard metal carbide phase dispersed in a continuous matrix of the metal binder alloy particles that are sintered to each other during thermal consolidation.

In certain embodiments, the process may further comprise shaping and/or finishing the composite material by grinding, lapping, and/or polishing to obtain a self-sharpening cutting blade insert for a knife, such as a pelletizing knife.

The materials, processes and examples described herein are for illustrative purposes only and are therefore not intended to be limiting, unless otherwise specified.

The following example is intended to illustrate various aspects of the present invention, and is not intended to limit the scope of the invention.

### Example

An exemplary composite material and properties thereof are described below. Table 1 lists the components used to make the composite material. Powders of the components were mixed and pressed to form green compacts using standard techniques, followed by thermal consolidation at a peak temperature of 1,440° C. using a slow ramp up at multiple temperature intervals to reach the peak temperature, soaking at the peak temperature, and slowly cooling.

TABLE 1

| Composite Material | Component | Amount (wt. %) |
|---|---|---|
| Hard metal carbide | Tungsten carbide (WC) | 70 |
| particles | | |
| Metal binder alloy | Cobalt (Co) | 24 |
| Metal binder alloy | Nickel (Ni) | 3 |
| Grain growth inhibitor | Chromium carbide | 2 |
| | (Cr₃C₂) | |
| Carbon scavenger | Tungsten metal powder | 1 |

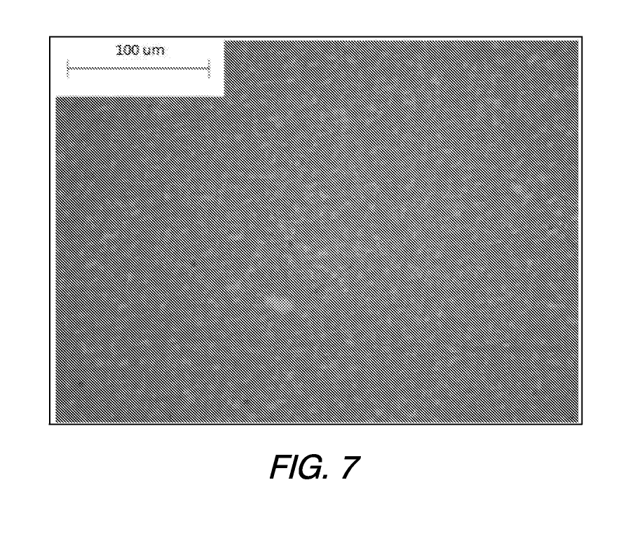

FIG. 7 is a micrograph of the resultant composite material. The WC hard metal carbide particles are present as a discontinuous phase (darker regions) dispersed in a continuous matrix of the Co/Ni binder alloy (lighter regions).

The composite material samples were tested and the results are summarized in Table 2.

TABLE 2

| | Standard | |
|---|---|---|
| Property | Test Method | Value |
| Wear Number | ASTM B611 | 1.88 |
| Wear Number(Adjusted | ASTM G65 | 7.59 |
| Volume Loss) | | |
| Hardness | ISO 3878 | 69 HRC; 86 HRA |
| Density | ISO 3369 | 12.6 g/cm³ |
| Typical Porosity | ISO 4505 | A02B00C00 |
| Transverse Rupture | ASTM B406 | 378 ± 114 ksi (2600 ± 785 MPa) |
| Strength | | |
| Coercivity | ISO 3326 | 104 Oe |

As used herein, unless indicated otherwise, the article “a” or “an” carries a singular or plural meaning and is therefore understood to mean “one or more.” For example, although reference is made herein to “a” grain growth inhibitor and “a” carbon scavenger, a plurality of these components can be used.

As used herein, “including,” “containing” and like terms are understood in the context of this invention to be synonymous with “comprising” and are therefore open-ended and do not exclude the presence of additional undescribed or unrecited elements, materials, ingredients or method steps. As used herein, “consisting of” is understood in the context of this invention to exclude the presence of any unspecified element, ingredient or method step. As used herein, “consisting essentially of” is understood in the context of this invention to include the specified elements, materials, ingredients or method steps “and those that do not materially affect the basic and novel characteristic(s)” of what is being described.

Where a closed or open-ended numerical range is described herein, all numbers, values, amounts, percentages, subranges and fractions within or encompassed by the numerical range are to be considered as being specifically included in and belonging to the original disclosure of this invention as if these numbers, values, amounts, percentages, subranges and fractions had been explicitly written out in their entirety.

Whereas particular embodiments of this invention have been described above for purposes of illustration, it will be evident to those skilled in the art that numerous variations of the details of the present invention may be made without departing from the invention as defined in the appended claims.

What is claimed is:

1. A pelletizer cutting knife comprising:
a wear surface;
a rake face having a rake angle of less than 90° with respect to the wear surface; and
a cutting edge at the intersection of the wear surface and the rake face, wherein at least a portion of the knife comprises a composite material comprising hard metal carbide particles dispersed in a metal binder alloy matrix.

2. The pelletizer cutting knife of claim 1, wherein the composite material comprises:
from 60 to 80 weight percent of the hard metal carbide particles; and
from 20 to 40 weight percent of the metal binder alloy.

3. The pelletizer cutting knife of claim 1, wherein the composite material has a hardness that is greater than 65 HRC and less than 75 HRC.

4. The pelletizer cutting knife of claim 1, wherein the wear surface sacrificially wears away at a faster rate than a die plate wear surface.

5. The pelletizer cutting knife of claim 1, wherein the cutting edge is self-sharpening.

6. The pelletizer cutting knife of claim 1, wherein the composite material has an abrasion resistance of at least 1.8 as measured by ASTM B611.

7. The pelletizer cutting knife of claim 1, wherein the composite material is provided in the form of an insert.

8. The pelletizer cutting knife of claim 7, wherein the insert is brazed or adhesively bonded onto a metal body portion of the knife.

9. A rotary knife hub assembly comprising:
a rotatable hub;
at least one pelletizer cutting knife mounted on the rotatable hub, wherein the knife comprises:
a wear surface;
a rake face having a rake angle of less than 90° with respect to the wear surface; and
a cutting edge at the intersection of the wear surface and the rake face, wherein at least a portion of the knife comprises a composite material comprising hard metal carbide particles dispersed in a metal binder alloy matrix.

10. The rotary knife hub assembly of claim 9, wherein the at least one pelletizer cutting knife is removably mounted on the rotatable hub by at least one mechanical fastener.

11. A pelletizing die and knife assembly comprising:
an extrusion die having a die plate wear surface and at least one extrusion orifice, and
at least one pelletizer cutting knife movable in relation to the extrusion die and having a wear surface contacting the die plate wear surface, wherein the wear surface of the knife comprises a composite material having a hardness of at least 65 HRC but less than a hardness of the die plate wear surface.

12. A composite material for use in a pelletizer cutting knife comprising:
from 20 to 40 weight percent of a metal binder alloy; and
from 60 to 80 weight percent of hard metal carbide particles dispersed in the metal binder alloy,
wherein the composite material has a hardness of from 65 to 75 HRC.

13. The composite material of claim 12, wherein the composite material comprises from 65 to 75 weight percent of the hard metal carbide particles and from 25 to 35 weight percent of the metal binder alloy.

14. The composite material of claim 12, wherein the hard metal carbide particles comprise tungsten carbide.

15. The composite material of claim 14, wherein the tungsten carbide particles have an average grain size of less than 3 μm.

16. The composite material of claim 14, wherein the hard metal carbide particles further comprise secondary metal carbide particles.

17. The composite material of claim 12, wherein the metal binder alloy comprises cobalt.

18. The composite material of claim 17, wherein the metal binder alloy further comprises nickel.

19. The composite material of claim 12, wherein the composite material further comprises from 0.01 to 5 weight percent of a grain growth inhibitor comprising chromium carbide, molybdenum carbide, tantalum carbide, niobium carbide, vanadium carbide, and combinations thereof.

20. The composite material of claim 12, wherein the composite material further comprises from 0.01 to 5 weight percent of a carbon scavenger comprising tungsten metal powder.

21. The composite material of claim 12, wherein the composite material has a hardness of from 65 to 75 HRC.

22. The composite material of claim 12, wherein the composite material has an abrasion resistance of from 1.8 to 2 as measured by ASTM B611.
